(19) United States
(12) Patent Application Publication
(10) Pub. No.: US 2007/0287626 A1
(43) Pub. Date: Dec. 13, 2007

(54) Process For The Preparation Of An Oxidic Catalyst Composition Comprising A Divalent And A Trivalent Metal

(76) Inventors: William Jones, Cambridge (GB); Dennis Stamires, Dana Point, CA (US); Paul O'Connor, Hoevelaken (NL); Michael F. Brady, Studio City, CA (US)

Correspondence Address: Albemarle Netherlands B.V.;Patent and Trademark Department, 451 Florida Street, Baton Rouge, LA, 70801, US

(21) Appl. No.: 10/582,305

(22) PCT Filed: Dec. 6, 2004
(86) PCT No.: PCT/EP04/13912

§ 371 Date: Jul. 5, 2007

Related U.S. Application Data
(60) Provisional application No. 60/527,756, filed on Dec. 9, 2003.

(30) Foreign Application Priority Data
Jan. 9, 2004 (EP) 04075063.0

(51) Int. Cl. B01J 23/10; B01J 29/06; B01J 35/00; B01J 37/03; C10G 11/04; C10G 11/05; C10G 45/04

(52) U.S. Cl. 502/73; 423/263; 423/299; 423/592.1; 423/594.17; 423/594.19; 423/604; 423/605; 423/606; 423/607; 423/608; 423/622; 423/632; 423/635; 502/60; 502/74

(57) ABSTRACT

Process for the preparation of an oxidic composition comprising a trivalent metal, a divalent metal and—calculated as oxide and based on the total composition—more than 18 wt % of one or more compounds selected from the group consisting of rare earth metal compounds, phosphorus compounds, and transition metal compounds, which process comprises the following steps: (a) preparing a precursor mixture comprising (i) a compound 1 being a trivalent metal compound, (ii) a compound 2 being a divalent metal compound, and (iii) a compound 3 being different from compounds 1 and 2 and being selected from the group consisting of rare earth metal compounds, phosphorus compounds, and transition metal compounds, (b) optionally aging the mixture, without anionic clay being formed, (c) drying the mixture, and (d) calcining the product of step c).

The resulting oxidic composition is suitable as a metal trap and SOₓ sorbent FCC processes.

The present invention relates to a process for the preparation of an oxidic catalyst composition comprising a divalent and a trivalent metal, an oxidic catalyst composition obtainable by this process, and the use of this oxidic catalyst composition in fluid catalytic cracking (FCC) processes.

EP-A 0 554 968 (W. R. Grace and Co.) relates to a composition comprising a coprecipitated ternary oxide comprising 30-50 wt % MgO, 5-30 wt % La₂O₃, and 30-50 wt % Al₂O₃. The composition is used in FCC processes for the passivation of metals (V, Ni) and the control of SOₓ emissions.

This document discloses two methods for preparing such a composition. In the first method, lanthanum nitrate, sodium aluminate, and magnesium nitrate are co-precipitated with sodium hydroxide from an aqueous solution, the precipitate is aged for 10-60 minutes at a pH of about 9.5 and 20-65° C., and then filtered, washed, dried, and calcined at a temperature of 450-732° C.

The second method differs from the first method in that the lanthanum nitrate and the sodium aluminate are co-precipitated and aged before the magnesium nitrate and the sodium hydroxide are added.

The object of the present invention is to provide a process for the preparation of an oxidic catalyst composition with improved metal trap capacity.

The invention relates to a process for the preparation of an oxidic catalyst composition comprising a trivalent metal, a divalent metal and—calculated as oxide and based on the total weight of the composition—more than 18 wt % of one or more compounds selected from the group consisting of rare earth metal compounds, phosphorus compounds, and transition metal compounds, which process comprises the following steps:
a) preparing a sodium-free precursor solution comprising (i) a compound 1 being a trivalent metal salt, (ii) a compound 2 being a divalent metal salt, and (iii) a compound 3 which is different from compounds 1 and 2 and is selected from the group consisting of rare earth metal salts, water-soluble phosphorus compounds, and transition metal salts,
b) forming a precipitate from the solution of step a) by adding a sodium-free base to the precursor solution,
c) optionally aging the precipitate,
d) drying the precipitate, and
e) calcining the dried precipitate.

Surprisingly, it has been found that with this process—which differs from that of EP-A 0 554 968 by the absence of sodium during the entire process—better metal traps are obtained. As will be shown in the Examples below, the presence of sodium in the precursor solution, either added in the form of sodium aluminate or NaOH, has a negative influence of the product's suitability as metal trap.

Even when the product is filtered and washed, the fact that sodium has been present during the preparation has a negative influence on the product's metal trap performance. It is theorised that the presence of sodium influences the crystallinity of the product. As shown in the examples, compositions prepared in the absence of sodium had a higher crystallinity than those prepared in the presence of sodium.

For various catalytic purposes, in particular fluid catalytic cracking, the presence of sodium is undesired. Because sodium-containing compounds are excluded in the process according to the invention, washing steps for removal of sodium from the resulting product are not necessary. This is a great advantage, because due to their colloidal nature, filtration of fresh precipitates is very slow.

Step a)

The first step of the process involves the preparation of a precursor solution comprising a trivalent metal salt (compound 1), a divalent metal salt (compound 2), and a compound selected from the group consisting of rare earth metal salts, water-soluble phosphorus compounds, and/or transition metal salts (compound 3).

Compound 1

Suitable trivalent metals include aluminium, gallium, indium, iron, chromium, vanadium, cobalt, manganese, niobium, lanthanum, and combinations thereof. Aluminium is the most preferred trivalent metal.

Suitable trivalent metal salts are nitrates, chlorides, sulfates, oxalates, formiates, and acetates, provided they are water-soluble.

compound 2

Suitable divalent metals include magnesium, zinc, nickel, copper, iron, cobalt, manganese, calcium, barium, strontium, and combinations thereof. Alkaline earth metals are the preferred divalent metals, with magnesium being the most preferred.

Suitable divalent metal salts are nitrates, chlorides, sulfates, oxalates, formiates, and acetates, provided they are water-soluble.

compound 3

Suitable rare earth metals include Ce, La, and mixtures thereof. Especially preferred is a mixture of Ce and La.

Suitable transition metals include Cu, Zn, Zr, Ti, Ni, Co, Fe, Mn, Cr, Mo, W, V, Rh, Ru, Pt, and mixtures thereof. These metals are preferably present in the precursor solution in the form of their nitrates, chlorides, sulfates, oxalates, formiates, and acetates, provided they are water-soluble.

Suitable water-soluble phosphorus compounds include phosphoric acid and its salts such as ammonium dihydrogen phosphate and diammonium hydrogen phosphate, ammonium hypophosphate, ammonium orthophosphate, ammonium dihydrogen orthophosphate, ammonium hydrogen orthophosphate, triammonium phosphate, sodium pyrophosphate, phosphines, and phosphites.

In a preferred embodiment, compound 1 is an aluminium salt, compound 2 is a magnesium salt, and compound 3 is a lanthanum salt. In an even more preferred embodiment, compound 1 is aluminium nitrate, compound 2 is magnesium nitrate, and compound 3 is lanthanum nitrate.

Step b)

A base is then added to the solution, thereby forming a precipitate. This base does not contain sodium.

Examples of suitable bases are potassium hydroxide, potassium carbonate, ammonium hydroxide, ammonium carbonate, ammonium hydroxy carbonate, lithium hydroxide, and alkaline earth metal hydroxides (e.g. Ca(OH)₂), with ammonium hydroxide being preferred.

The amount of base to be added and the pH to be reached by said base addition depend on the types of salts to be precipitated and can be easily determined by the skilled person.

Step c)

The precipitate is optionally aged. Suitable aging conditions are temperatures in the range 20-200° C., preferably 50-160° C., and autogeneous pressure. Aging is preferably conducted from 0.5-48 hours, more preferably 0.5-24 hours, most preferably 1-6 hours.

During aging, an anionic clay may be formed. Anionic clays—also called hydrotalcite-like materials or layered double hydroxides—are materials having a crystal structure consisting of positively charged layers built up of specific combinations of divalent and trivalent metal hydroxides between which there are anions and water molecules, according to the formula
[Mₘ²⁺Mₙ³⁺(OH)₂ₘ₊₂ₙ.]X_{n/z}^{z-}.bH₂O
wherein M²⁺ is a divalent metal, M³⁺ is a trivalent metal, and X is an anion with valency z. m and n have a value such that m/n=1 to 10, preferably 1 to 6, more preferably 2 to 4, and most preferably close to 3, and b has a value in the range of from 0 to 10, generally a value of 2 to 6, and often a value of about 4.

Hydrotalcite is an example of a naturally occurring anionic clay wherein Mg is the divalent metal, Al is the trivalent metal, and carbonate is the predominant anion present. Meixnerite is an anionic clay wherein Mg is the divalent metal, Al is the trivalent metal, and hydroxyl is the predominant anion present.

However, in a preferred embodiment, the precipitate is aged under such conditions that anionic clay formation is prevented. Aging conditions which influence the rate of anionic clay formation are the temperature (the higher the temperature, the faster the reaction), the pH (the higher the pH, the faster the reaction), the identity of compounds 1 and 2, and the presence of additives that inhibit anionic clay formation (e.g. vanadium, sulfate).

If the formation of anionic clay is prevented, calcination (step e) results in the formation of compositions comprising individual, discrete oxide entities of divalent metal oxide and trivalent metal oxide. In the case of Mg as the divalent and Al as the trivalent metal, this results in the formation of both acidic (Al₂O₃) and basic (MgO) sites being accessible to molecules to be adsorbed or to be converted in catalytic reactions.

Consequently, this enables the entrapment of both acidic compounds (e.g. S-heterocycles, SOx, V-containing compounds) and basic compounds (e.g. N-heterocycles, Ni-containing compounds).

Step d)

The precipitate, whether aged or not, is dried to such an extent as to render it suitable for calcination. Drying can be performed by any method, such as spray-drying, flash-drying, flash-calcining, and air drying.

Step e)

The dried precipitate is calcined at a temperature in the range of 200-800° C., more preferably 300-700° C., and most preferably 350-600° C. Calcination is conducted for 0.25-25 hours, preferably 1-8 hours, and most preferably 2-6 hours. All commercial types of calciners can be used, such as fixed bed or rotating calciners.

Calcination can be performed in various atmospheres, e.g, in air, oxygen, inert atmosphere (e.g. N₂), steam, or mixtures thereof.

Preferably, the calcination conditions are chosen such that spinel formation is prevented, as spinel is not very active as metal trap.

It is possible to add an additive before or during calcination of the precipitate. Examples of such additives are alkaline earth metals (for instance Ca and Ba), transition metals (for example Cr, Mn, Fe, Co, Ti, Zr, Cu, Ni, Zn, Mo, W, V, Sn, Nb, Rh, Ru), actinides, noble metals such as Pt and Pd, gallium, titanium, and mixtures thereof. It is furthermore possible to mix the precipitate with additional catalyst ingredients before calcination. Examples of such catalyst ingredients are matrix or filler materials (e.g. clay such as kaolin, titanium oxide, zirconia, alumina, silica, silica-alumina, bentonite, etc.) and molecular sieve material (e.g. zeolite Y, USY, REY, RE-USY, zeolite beta, ZSM-5, etc.).

The Oxidic Catalyst Composition

The weight percentage of compound 1 in the oxidic catalyst composition according to the invention preferably is 10 to 60 wt %, more preferably 20 to 40 wt %, and most preferably 25 to 35 wt %, calculated as oxide and based on the total weight of the catalyst composition.

The weight percentage of compound 2 in the oxidic catalyst composition preferably is 10 to 60 wt %, more preferably 20 to 40 wt %, and most preferably 25 to 35 wt %, calculated as oxide and based on the total weight of the catalyst composition.

The weight percentage of compound 3 in the oxidic catalyst composition is at least 18 wt %, preferably 18 to 60 wt %, more preferably 20 to 40 wt %, and most preferably 25 to 35 wt %, calculated as oxide and based on the total weight of the catalyst composition.

As evidenced by the Examples below, the process of the invention enables the formation of compositions with a higher crystallinity and a better metal trap performance than the processes disclosed in EP-A 0 554 968.

In particular, the process according to the present invention enables the preparation of MgO-containing oxidic catalyst compositions with highly crystalline MgO. The invention therefore also relates to a Mg-containing oxidic catalyst composition obtainable by the process of the invention, wherein the MgO diffraction reflection at about 43° 2-theta in the Powder X-Ray Diffraction pattern (according to JCPDS 04/0829: 42.906° 2θ)—measured with Cu K-α radiation—has a full width at half maximum (FWHM) of less than 1.5° 2-theta, more preferably less than than 1.0° 2-theta, even more preferably less than 0.6° 2-theta, and most preferably less than 0.4° 2-theta.

Use of the Oxidic Catalyst Composition

The oxidic catalyst composition obtainable by the process according to the invention can suitably be used in or as a catalyst or catalyst additive in a hydrocarbon conversion, purification, or synthesis process, particularly in the oil refining industry and Fischer-Tropsch processes. Examples of processes where these compositions can suitably be used are catalytic cracking, hydrogenation, dehydrogenation, hydrocracking, hydroprocessing (hydrodenitrogenation, hydrodesulfurisation, hydrodemetallisation), polymerisation, steam reforming, base-catalysed reactions, gas-to-liquid conversions (e.g. Fischer-Tropsch), processing of heavy resid oils, and the reduction of SOₓ and NOₓ emissions from the regenerator of an FCC unit.

It can be used in both fixed bed and fluidised bed processes.

In particular, the oxidic catalyst compositions obtainable by the process according to the invention are very suitable for use in FCC processes for the entrapment of metals like V and Ni. At the same time, they can also be used for the reduction of SOₓ and NOₓ emissions and the reduction of the sulfur and nitrogen contents of fuels like gasoline and diesel.

The product obtainable from the process according to the invention can be added to the FCC unit as such or in a composition containing conventional FCC catalyst ingredients, such as matrix or filler materials (e.g. clay such as kaolin, titanium oxide, zirconia, alumina, silica, silica-alumina, bentonite, etc.) and molecular sieve material (e.g. zeolite Y, USY, REY, RE-USY, zeolite beta, ZSM-5, etc.). Therefore, the present invention also relates to a catalyst particle containing the oxidic catalyst composition according to the present invention, a matrix or filler material, and a molecular sieve.

### FIGURES

FIG. 1 shows a powder X-ray diffraction (PXRD) pattern of the oxidic catalyst composition obtained in Example 1.

FIG. 2 shows a powder X-ray diffraction (PXRD) pattern of the oxidic catalyst composition obtained in Example 2.

FIG. 3 shows a powder X-ray diffraction (PXRD) pattern of the composition obtained in Comparative Example 3.

FIG. 4 shows a powder X-ray diffraction (PXRD) pattern of the composition obtained in Comparative Example 4.

FIG. 5 shows a powder X-ray diffraction (PXRD) pattern of the composition obtained in Comparative Example 5.

### EXAMPLES

### Example 1

A precursor solution was prepared by dissolving 298.82 g Al(NO₃)₃·9 H₂O, 502.96 g Mg(NO₃)₂·6 H₂O, and 126.67 g La(NO₃)₃·6 H₂O in 1851.2 g distilled water. This solution and a 13 wt % ammonium hydroxide solution were added simultaneously to 500 g distilled water in a beaker with stirring, with the pH being kept at 9 by controlling the rate of addition of each solution. When the entire precursor solution had been added, the resulting slurry was dried directly at 115° C., without filtering and washing. The dried powder was calcined at 500° C. for 4 hours.

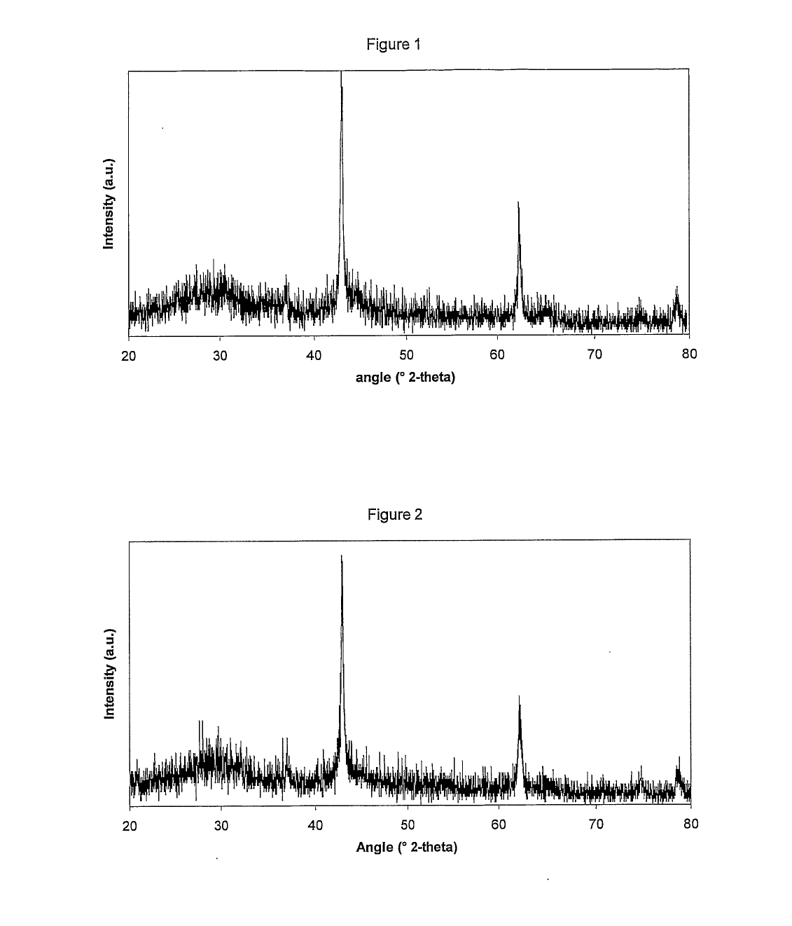

The resulting product contained 28.6 wt % lanthanum, calculated as La₂O₃. The PXRD (Cu K-α radiation) of the resulting product is shown in FIG. 1. The full width at half maximum (FWHM) of the reflection at 43° 2-theta is indicated in Table 1 below.

### Example 2

Example 1 was repeated, except that the slurry containing the formed precipitate was stirred overnight at 85° C. No anionic clay was formed during this period.

The PXRD (Cu K-α radiation) of the calcined product is shown in FIG. 2. The full width at half maximum (FWHM) of the reflection at 43° 2-theta is indicated in Table 1 below.

### Comparative Example 3

A precursor solution was prepared by dissolving 134.47 g aluminum nitrate, 226.33 g magnesium nitrate, and 57.00 g lanthanum nitrate in 1851.2 g distilled water. This solution and a 25 wt % sodium hydroxide solution were added simultaneously to 300 g distilled water in a beaker with stirring, with the pH being kept at 9 by controlling the rate of addition of each solution. After all the metal nitrate solution had been added, the slurry containing the formed precipitate was immediately dried at 115° C. The dried powder was calcined at 500° C. for 4 hours.

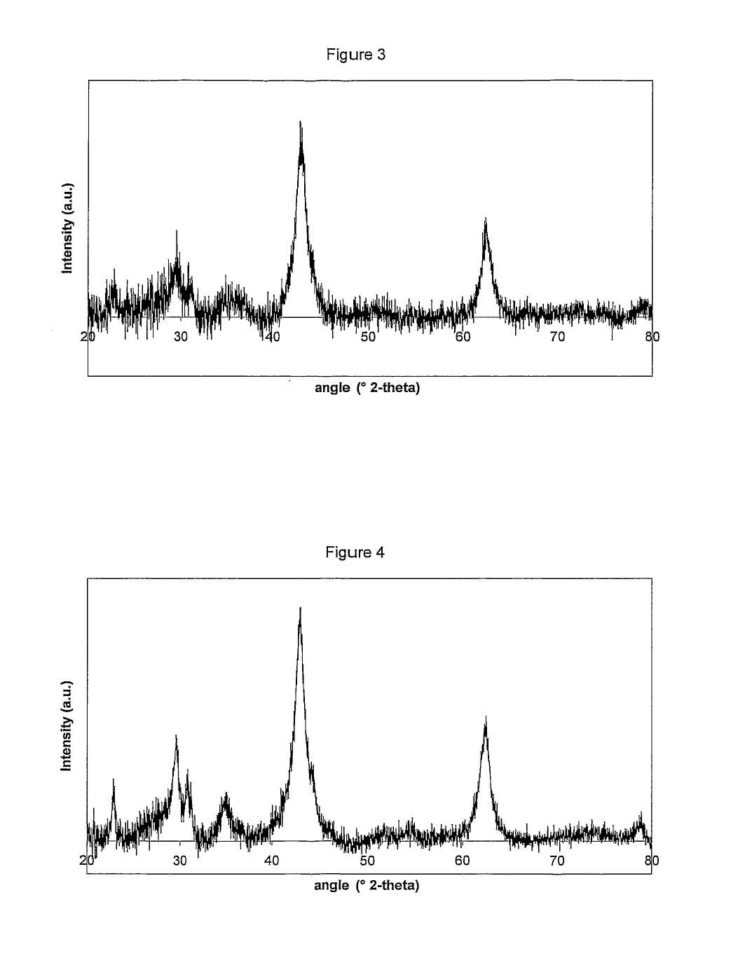

The resulting product contained 28.6 wt % lanthanum, calculated as La₂O₃. The PXRD (Cu K-α radiation) of the resulting product is shown in FIG. 3. The full width at half maximum (FWHM) of the reflection at 43° 2-theta is indicated in Table 1 below.

Comparative Example 4

Comparative Example 3 was repeated, except that the slurry containing the formed precipitate was stirred overnight at 85° C. Anionic clay formation was observed during this period.

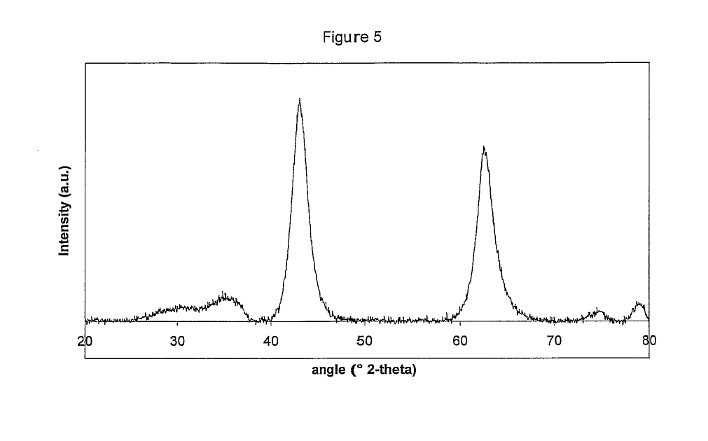

The PXRD (Cu K-α radiation) of the resulting product is shown in FIG. 4. The full width at half maximum (FWHM) of the reflection at 43° 2-theta is indicated in Table 1 below.

### Comparative Example 5

Example 1 of EP-A 0 554 968 was repeated.

An acidic and a basic stream were simultaneously fed into a reactor containing 400 g of water. The reactor temperature was maintained at 40° C. with high-speed stirring. The acidic stream contained 65.4 g of MgO and 41.3 g La₂O₃, both in the form of the corresponding nitrates, in a total volume of 984 ml. The basic stream contained 65.6 g of Al₂O₃ in the form of aluminium nitrate and 32.1 g of 50 wt % NaOH solution, in a total volume of 984 ml. The streams were fed at an equal rate of about 40 ml/minute. At the same time, a 16 wt % NaOH solution was fed to the reactor in order to adjust the pH in the reactor to 9.5. After aging of the resulting slurry for 60 minutes, it was filtered and washed with distilled water. After overnight drying in a 120° C. oven, the material was calcined at 704° C. for 2 hours.

The PXRD pattern of the resulting product is shown in FIG. 5. The full width at half maximum (FWHM) of the reflection at 43° 2-theta is indicated in Table 1 below.

### Comparative Example 6

A process was conducted according to FIG. 1 of EP-A 0 554 968.

An acidic and a basic stream were simultaneously fed into a reactor containing 400 g of water. The reactor temperature was maintained at 40° C. with high-speed stirring. The acidic feedstream contained 41.3 g of La-rich rare earth oxide in the form of nitrate, in a total volume of 984 ml. The basic feedstream had a sodium aluminate solution bearing 65.6 g of Al₂O₃ along with 32.1 g of 50 wt % sodium hydroxide solution, in a total volume of 984 ml. While these two streams were fed at an equal rate of about 40 ml/minute, the feed rate of a 16 wt % sodium hydroxide solution was adjusted so as to control pH of the slurry in the kettle at 9.5. After aging the slurry under this condition for 60 minutes, an acidic feedstream containing 65.4 g of MgO in the form of nitrate, in a total volume of 984 ml., was added while maintaining the pH at 9.5 with a 16 w % percent sodium hydroxide solution. The slurry was immediately filtered and washed using distilled water and dried overnight. After overnight drying in a 120° C. oven, the material was air calcined at 704° C. for 2 hours.

In the PXRD pattern of the resulting product, the MgO reflection could not be resolved.

### Example 7

The suitability of the materials prepared in the above examples was tested as a metal trap.

In this test 1 gram of a blend of 50 wt % of zeolite particles (containing 75 wt % zeolite Y in a silica matrix), 5 wt % of a composition according to one of the Examples above, 5 wt% of inert particles (80 wt % kaolin in a silica matrix), and 40 wt % of V-impregnated FCC catalyst particles was steamed in a fixed bed at 788° C. for 5 hours. The particles were all about 68 microns in diameter.

The micropore volume (MiPV) of the zeolite Y was measured before and after the test using nitrogen adsorption.

Vanadium causes the micropore volume of the zeolite Y to deteriorate. So, the better the vanadium passivating capacity of the sample, the higher the micropore volume of the zeolite that will be retained in this measurement.

The micropore volume retention (percentage of MiPV left after steaming) of the zeolite in the presence of the compositions according to the different Examples is indicated in Table 1 below and is compared with that of compounds that are known to be suitable as metal traps: hydrotalcite and barium titanate.

TABLE 1

| | | FWHM of the 43° |
|---|---|---|
| | MiPV retention (%) | 2-theta reflection |
| Example 1 | 89 | 0.29 |
| Example 2 | 92 | 0.36 |
| Comparative Example 3 | 77 | 1.60 |
| Comparative Example 4 | 62 | 1.80 |
| Comparative Example 5 | 75 | 2.05 |
| Comparative Example 6 | 56 | n.a. |
| hydrotalcite | 74 | |
| barium titanate | 78 | |

These results show that the process according to the invention leads to better metal traps than the process of EP-A 0 554 968. The compositions according to the invention are even better metal traps than conventional metal trap materials such as hydrotalcite and barium titanate.

Further, Table 1 shows that the compositions prepared according to the invention, with ammonium hydroxide as base, are better metal traps than compositions prepared according to the same method but using NaOH as a base, even though the latter materials were filtered and washed in order to remove unwanted ions.

From the MgO reflection widths in Table 1 it can be concluded that in the absence of sodium an MgO phase of higher crystallinity (i.e. narrower MgO reflection) was formed than in the presence of sodium.

1. Process for the preparation of an oxidic catalyst composition comprising a trivalent metal, a divalent metal and—calculated as oxide and based on the total weight of the composition—more than 18 wt % of one or more compounds selected from the group consisting of rare earth metal compounds, phosphorus compounds, and transition metal compounds, which process comprises the following steps:
a) preparing a sodium-free precursor solution comprising (i) a compound 1 being a trivalent metal salt, (ii) a compound 2 being a divalent metal salt, and (iii) a compound 3 which is different from compounds 1 and 2 and is selected from the group consisting of rare earth metal salts, water-soluble phosphorus compounds, and transition metal salts,
b) forming a precipitate from the solution of step a) by adding a sodium-free base to the precursor solution,
c) optionally aging the precipitate,
d) drying the precipitate, and
e) calcining the dried precipitate.

2. A process according to claim 1 wherein the sodium-free base added in step b) is ammonium hydroxide.

3. A process according to claim 1 wherein the precipitate is aged in step c) without anionic clay being formed.

4. A process according to claim 1 wherein the divalent metal of compound 2 is selected from the group consisting of Mg, Ca, Ba, Zn, Ni, Cu, Co, Fe, Mn, and mixtures thereof.

5. A process according to claim 1 wherein the trivalent metal of compound 1 is selected from the group consisting of Al, Ga, Fe, Cr, and mixtures thereof.

6. A process according to claim 1 wherein compound 3 is a compound comprising a metal selected from the group consisting of Cu, Zn, Zr, Ti, Ni, Co, Fe, Mn, Cr, Mo, W, V, Pt, Ru, Rh, Ce, La, and mixtures thereof.

7. A process according to claim 6 wherein compound 3 is present in the composition in a total amount of 18 to 60 wt %, calculated as oxide and based on the total composition.

8. Oxidic catalyst composition obtainable by the process according to claim 1.

9. An oxidic catalyst composition according to claim 8 wherein the divalent metal is Mg and the MgO reflection at 43° 2-theta in the Powder X-Ray Diffraction pattern—measured with Cu K-α radiation—has a full width at half maximum of less than 1.5° 2-theta.

10. An oxidic catalyst composition according to claim 9 wherein the full width at halfmaximum is less than 1.0° 2-theta, preferably less than 0.6° 2-theta, more preferably less than 0.4° 2-theta.

11. Catalyst particle comprising the oxidic catalyst composition according to claim 8, a matrix or filler material, and a molecular sieve.

12. Use of the oxidic catalyst composition of claim 8 in a fluid catalytic cracking process.

13. Use of the catalyst particle of claim 11 in a fluid catalytic cracking process.
